(19) United States
(12) Patent Application Publication
(10) Pub. No.: US 2026/0270611 A1
(43) Pub. Date: Sep. 10, 2026

(54) Acoustic Transmission Channel for an Electronic Device

(71) Applicant: Google LLC, Mountain View, CA (US)

(72) Inventors: Shengyin Ding, Cupertino, CA (US); Chuan-Hsien Cheng, San Jose, CA (US)

(73) Assignee: Google LLC, Mountain View, CA (US)

(21) Appl. No.: 19/657,446

(22) Filed: Apr. 24, 2026

(51) Int. Cl. H04R 1/34; G06F 1/16; G06F 1/18

(52) U.S. Cl. CPC H04R 1/345; G06F 1/1688; G06F 1/181; H04R 2499/11

(57) ABSTRACT

An acoustic structure for an electronic device routes audio from an internal audio driver to an external environment. The acoustic structure includes an acoustic channel fluidly coupling the internal audio driver to an acoustic outlet located at a periphery of a housing. The acoustic channel includes an inlet adjacent to the audio driver having a triangular shape and extends at an oblique angle toward the acoustic outlet to route acoustic waves around an adjacent internal space. The acoustic channel comprises asymmetric lateral boundaries, featuring a substantially straight first wall and a spaced apart second wall having a curved profile. The curved profile is characterized by alternating positive and negative curvatures. This geometric configuration facilitates the fluid dynamic routing of acoustic waves from an offset internal position, directing the acoustic output to manage sound intensity distribution and acoustic energy transmission.

### SUMMARY

This document describes techniques and apparatuses, implemented on mobile devices (e.g., smartphones, tablet computers, or other portable electronic devices), directed at an acoustic transmission channel for an electronic device. The described apparatuses provide a structural configuration that routes acoustic waves from an offset internal audio driver around an internally constrained component, such as a camera, to an acoustic outlet. This facilitates fluid dynamic routing to manage sound intensity distribution and acoustic energy transmission.

In general, a first aspect of the present disclosure relates to an electronic device. The electronic device includes a housing and a display assembly coupled to the housing. The electronic device includes an acoustic outlet defined at a periphery of the electronic device. A camera is disposed within the housing. The electronic device includes an audio driver disposed within the housing and laterally offset from the camera. The electronic device also includes an acoustic channel defined within the housing and fluidly coupling the audio driver to the acoustic outlet. The acoustic channel includes an inlet opening adjacent to the audio driver, the inlet opening having a substantially triangular shape. The acoustic channel includes a first wall extending from the inlet opening toward the acoustic outlet, and a second wall spaced apart from the first wall. The second wall is disposed between the camera and the first wall. The first wall is substantially straight and the second wall includes a curved profile. In general, another aspect of the present disclosure relates to an acoustic structure for an electronic device. The acoustic structure includes an enclosure, an audio driver disposed within the enclosure, and an acoustic outlet formed at an exterior of the enclosure. The acoustic structure includes an acoustic channel fluidly coupling the audio driver to the acoustic outlet. The acoustic channel includes an inlet opening coupled to the audio driver, the inlet opening shaped as a substantially right-angled triangle. The acoustic channel includes a substantially straight first wall extending from the inlet opening to the acoustic outlet. The acoustic channel also includes a curved second wall extending from the inlet opening to the acoustic outlet and spaced apart from the first wall. The acoustic channel includes a substantially constant cross-sectional depth from the inlet opening to the acoustic outlet.

This Summary is provided to introduce simplified concepts for an acoustic transmission channel for an electronic device, which is further described below in the Detailed Description and is illustrated in the Drawings. This Summary is intended neither to identify essential features of the claimed subject matter nor for use in determining the scope of the claimed subject matter.

### BRIEF DESCRIPTION OF THE DRAWINGS

The details of one or more aspects of an acoustic transmission channel for an electronic device are described throughout the disclosure, with reference to the drawings. The use of the same reference numbers in different instances in the detailed description and the drawings indicates same or similar elements:

FIG. 1 illustrates top views of a display assembly and an enclosure for an acoustic transmission channel for an electronic device;

FIG. 2 illustrates back views of an enclosure for an acoustic transmission channel for an electronic device;

FIG. 3 illustrates a partial back view of an enclosure for an acoustic transmission channel for an electronic device;

FIG. 4 illustrates a cross-sectional view of an acoustic structure for an acoustic transmission channel for an electronic device;

FIG. 5 illustrates a detailed geometric view of an acoustic channel for an acoustic transmission channel for an electronic device.

### DETAILED DESCRIPTION

Electronic devices, such as mobile phones, tablet computers, and other portable hardware, provide audio output for media playback, telecommunications, and other user interactions. As these devices integrate a multitude of internal components (e.g., optical sensors, cameras, displays) within compact housing form factors, the spatial arrangement of audio drivers and acoustic routing pathways becomes constrained. A user interacting with such a device typically experiences an external sound field generated by the internal audio components. To provide an effective user experience, this sound field may be managed to remain uniform and clear, regardless of slight variations in how the device is held or positioned relative to the user's ear.

To accommodate internal component packaging while managing audio transmission, an acoustic structure may be implemented to route sound from an internally offset audio driver to an external acoustic outlet. The acoustic structure can utilize an acoustic transmission channel that fluidly couples the driver to an exit slot on the device periphery. This arrangement guides acoustic waves around intervening internal spaces, such as an area occupied by a camera module. By employing an acoustic channel with a substantially triangular inlet that extends at an oblique angle toward the device periphery, the acoustic output can be structurally directed from an offset origin to a desired exit location.

The transmission of acoustic energy through this channel may be managed using asymmetric lateral boundaries designed to facilitate fluid dynamic routing. For instance, the acoustic channel may feature a substantially straight first wall paired with a spaced apart second wall having a curved profile. The curved profile, which can incorporate alternating convex and concave portions relative to the channel interior, smoothly navigates acoustic waves around the physical footprint of the adjacent internal spaces. This geometric configuration aids in transitioning the acoustic energy from the audio driver to the external environment.

Implementing this diagonally expanding, asymmetrically bordered acoustic channel can provide several functional technical effects. The geometry facilitates acoustic radiation and manages sound intensity distribution, mitigating acoustic energy loss as the sound waves travel through the internal enclosure. Additionally, this configuration can broaden the external listening area, allowing the user to experience consistent audio volume and clarity across a wider range of physical device positions. Further, the routing structure allows for a compact acoustic footprint, preserving internal volume for other electronic components while maintaining the structural integrity of the surrounding housing and display assemblies.

### Example Environment

The following discussion describes an operating environment, techniques that may be employed in the operating environment, and various devices or systems in which components of the operating environment may be embodied. In the context of the present disclosure, reference is made to the operating environment by way of example only.

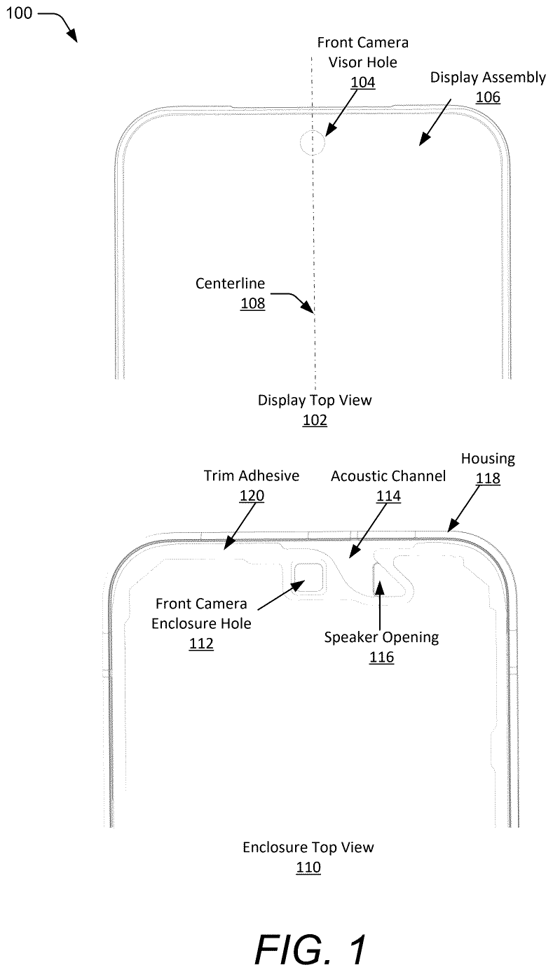

FIG. 1 illustrates top views of a display assembly and an enclosure for an acoustic transmission channel for an electronic device. An overall diagram 100 depicts two related structural layouts representing different physical layers of a portable electronic device. The overall diagram 100 portrays an architecture that a manufacturer can implement across a wide variety of electronic hardware configurations. For example, the electronic device depicted by the overall diagram 100 may include smartphones, tablet computers, wearable computing devices, augmented reality headsets, laptop computers, smart home hubs, or portable gaming consoles. The overall diagram 100 visually separates an upper user-facing assembly from a lower internal chassis assembly to show how internal structures route acoustic energy around constrained hardware footprints.

The overall diagram 100 includes a display top view 102. The display top view 102 illustrates a display assembly 106, which represents a front-facing or exterior-facing panel of the electronic device. The display top view 102 shows an arrangement of visual and optical components as a manufacturer may orient them relative to a user interacting with the device. As shown in the display top view 102, a front camera visor hole 104 provides a transparent, translucent, or physically unobstructed region for an underlying optical sensor to receive light from an external environment. The front camera visor hole 104 is situated within a display assembly 106. The display assembly 106 provides visual output to the user and can receive touch inputs from the user. The display assembly 106 can include various display technologies and stacked layers, such as, for example, organic light-emitting diode (OLED) panels, active-matrix organic light-emitting diode (AMOLED) panels, liquid crystal display (LCD) panels, touch-sensitive capacitive layers, cover glass plates, or optical adhesives. A centerline 108 provides a geometric reference axis running longitudinally through the display assembly 106. In some implementations, the centerline 108 intersects the front camera visor hole 104, indicating that an underlying optical sensor sits centrally along a top edge portion of the display assembly 106.

The overall diagram 100 also features an enclosure top view 110. The enclosure top view 110 illustrates an underlying mechanical framework, midframe, housing, or chassis to which the display assembly 106 physically attaches. Located within this underlying framework is a front camera enclosure hole 112. The front camera enclosure hole 112 forms a physical void, bracket, or receptacle shaped to house various internal hardware components. For example, the front camera enclosure hole 112 may house a front-facing visible light camera module, an infrared sensor, a facial recognition scanner, an ambient light sensor, a proximity sensor, or a time-of-flight (ToF) depth sensor. When a manufacturer assembles the electronic device, the front camera enclosure hole 112 aligns spatially with the front camera visor hole 104 along the centerline 108. The front camera enclosure hole 112 thus permits ambient light to pass through the display assembly 106 and enter the hardware housed within the front camera enclosure hole 112.

Laterally offset from the front camera enclosure hole 112, the underlying framework illustrated by the enclosure top view 110 includes an acoustic channel 114. The acoustic channel 114 forms a recessed pathway, duct, trench, groove, or conduit within the physical structure of the enclosure. The acoustic channel 114 originates at a speaker opening 116. The speaker opening 116 serves as an inlet opening for the acoustic channel 114. The speaker opening 116 receives acoustic energy from an internal audio driver situated below the enclosure. The speaker opening 116 exhibits a substantially triangular shape that sits laterally offset from the centerline 108. From the speaker opening 116, the acoustic channel 114 extends at an oblique angle relative to the centerline 108. The acoustic channel 114 routes diagonally outward toward a peripheral edge of the device, maneuvering around a physical footprint of the front camera enclosure hole 112. The acoustic channel 114 features a substantially straight first wall and a curved second wall that smoothly navigates acoustic waves around the hardware housed in the front camera enclosure hole 112.

A housing 118 provides structural boundaries for these internal components. The housing 118 forms an outer physical shell, external housing, and internal support scaffolding for the electronic device. The housing 118 may be formed from a wide variety of rigid or semi-rigid materials. For example, the housing 118 may comprise milled aluminum, stainless steel, titanium, injected polycarbonate, glass, carbon fiber composites, magnesium alloy, or synthetic composite plastics. A trim adhesive 120 (e.g., an adhesive layer) physically bonds the display assembly 106 to the housing 118. The trim adhesive 120 runs along a perimeter of the housing 118 and traces boundaries of the acoustic channel 114. In addition to securing the display assembly 106, the trim adhesive 120 acts as an acoustic sealing gasket. The trim adhesive 120 bridges a physical gap between the housing 118 and the display assembly 106, completing sealed upper and lateral boundaries of the acoustic channel 114. The trim adhesive 120 may be formed from various bonding materials, such as, for example, pressure-sensitive adhesives (PSA), heat-activated films, epoxies, silicone-based sealants, or double-sided tapes.

In an example, the components illustrated in the overall diagram 100 collaborate to deliver sound to a user while accommodating centrally located optical sensors. An internal audio driver generates acoustic waves. The internal audio driver introduces the acoustic waves upward into the speaker opening 116. The speaker opening 116 directs the acoustic waves into the internal volume of the acoustic channel 114. As the acoustic waves travel through the acoustic channel 114, the acoustic channel 114 guides a fluid medium (e.g., air) diagonally around the front camera enclosure hole 112 based on a geometric profile of the acoustic channel 114. The display assembly 106 acts as a physical ceiling for the acoustic channel 114, while the housing 118 provides a structural floor and outer lateral walls. The acoustic channel 114 fluidly couples the speaker opening 116 to an external environment at the peripheral edge of the housing 118, delivering sound to a user. Concurrently, a camera positioned within the front camera enclosure hole 112 captures optical data through the front camera visor hole 104 of the display assembly 106. The acoustic channel 114 allows the electronic device to emit directed audio without physically interfering with an optical path or a physical footprint of the front camera enclosure hole 112.

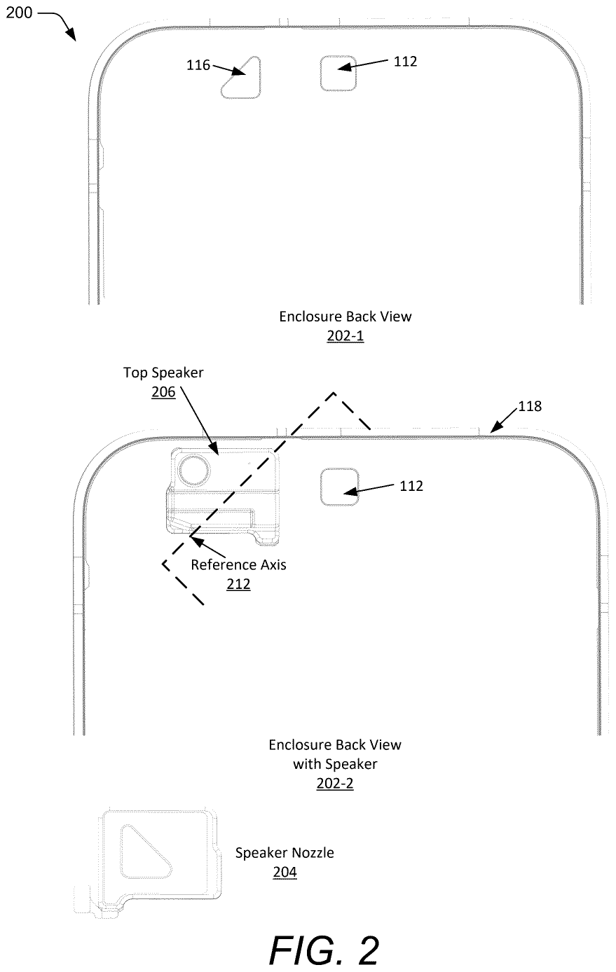

FIG. 2 illustrates back views of an enclosure for an acoustic transmission channel for an electronic device. An overall back view diagram 200 portrays interior, rear-facing perspectives of an internal chassis or structural midframe of an electronic device. The overall back view diagram 200 illustrates how internal hardware cavities and acoustic routing structures reside relative to one another within the electronic device. In some implementations, a manufacturer may implement the electronic device represented by the overall back view diagram 200 in a wide variety of portable computing platforms.

As illustrated in the overall back view diagram 200, a front camera enclosure hole 112 provides a designated physical receptacle for housing optical hardware. The front camera enclosure hole 112 forms a generally rectangular or square void through the enclosure. In some implementations, the front camera enclosure hole 112 may receive and physically support a variety of optical or sensing components. For example, the front camera enclosure hole 112 may house a visible light front-facing camera, an infrared camera, a proximity sensor, an eye-tracking sensor, a thermal imaging scanner, or an optical image stabilization mechanism.

Positioned laterally offset from the front camera enclosure hole 112, the housing 118 shown in the overall back view diagram 200 features a speaker opening 116. The speaker opening 116 defines a substantially triangular cutout or aperture through the enclosure. The speaker opening 116 acts as an ingress port for acoustic energy to pass from the rear interior of the device through to a fluidly coupled acoustic channel situated on the opposite (front) side of the enclosure. A housing 118 borders both the front camera enclosure hole 112 and the speaker opening 116, providing the rigid outer perimeter and structural scaffolding for the enclosure. The housing 118 bounds the internal volume of the electronic device. A manufacturer can form the housing 118 from a wide range of rigid or semi-rigid materials.

The upper portion of the overall back view diagram 200 includes an enclosure back view 202-1. The enclosure back view 202-1 shows a bare structural framework of the housing 118, visually isolating physical voids and boundaries without hardware components blocking the perspective. Because the enclosure back view 202-1 illustrates the internal side of the device, the spatial arrangement horizontally mirrors the front side. The middle portion of the overall back view diagram 200 features an enclosure back view with speaker 202-2. The enclosure back view with speaker 202-2 illustrates the same underlying chassis as the enclosure back view 202-1, but illustrates the internal volume populated with an active audio driving component.

To interface properly with the speaker opening 116, an audio driver assembly illustrated in the enclosure back view with speaker 202-2 includes a speaker nozzle 204. The overall back view diagram 200 shows the speaker nozzle 204 both attached to an audio driver and physically isolated at the bottom of the overall back view diagram 200. The speaker nozzle 204 defines the physical sound exit port of an audio driver assembly. The speaker nozzle 204 features a substantially triangular physical profile that can mirror and fit within or against the speaker opening 116. A top speaker 206 sits within the internal cavity defined by the housing 118 and couples to the speaker nozzle 204 over the speaker opening 116. The top speaker 206 functions as an electromechanical transducer that converts electrical audio signals into physical acoustic waves. The top speaker 206 may include various acoustic driver technologies, such as, for example, a dynamic driver, a piezoelectric transducer, a balanced armature driver, or a micro-electromechanical system (MEMS) speaker module. The top speaker 206 generates the acoustic energy that the device eventually directs to the user.

A reference axis 212 denotes an imaginary geometric projection or phantom line illustrating the diagonal alignment of the top speaker 206 and the surrounding acoustic structure. The reference axis 212 intersects the top speaker 206 at an oblique angle relative to the longitudinal boundaries of the housing 118, indicating the trajectory along which the top speaker 206 and the speaker nozzle 204 direct acoustic waves.

In operation, the components shown in the overall back view diagram 200 interact to manage the generation and routing of audio inside the device. The top speaker 206 receives an electrical signal and generates acoustic energy. The top speaker 206 pushes this acoustic energy outward through the speaker nozzle 204. The speaker nozzle 204 funnels a fluid medium carrying the acoustic waves directly into the speaker opening 116. Because the speaker opening 116 and the speaker nozzle 204 share a substantially triangular geometry and align along the oblique reference axis 212, the top speaker 206 pushes the acoustic waves diagonally outward. The speaker opening 116 passes the fluid medium through the enclosure, routing the sound waves away from the physical hardware situated within the front camera enclosure hole 112. This structural arrangement allows the top speaker 206 to deliver sound to a fluidly coupled acoustic channel on the opposite side of the enclosure without causing physical interference with the camera components.

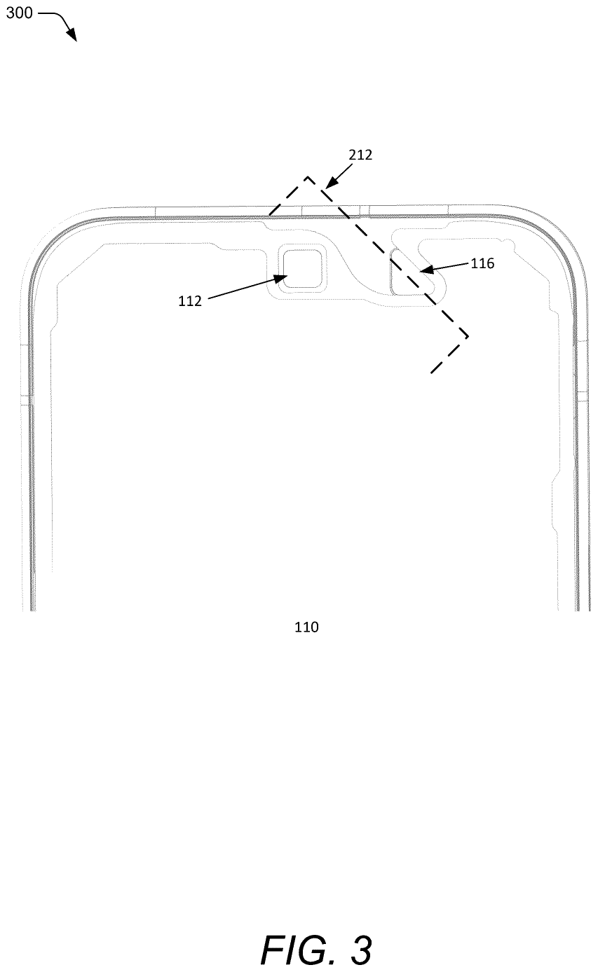

FIG. 3 illustrates a partial back view of an enclosure for an acoustic transmission channel for an electronic device. An enclosure detail diagram 300 provides a magnified perspective of structural routing geometries situated along an upper peripheral boundary of an electronic device chassis. In some implementations, the enclosure detail diagram 300 portrays an architecture that manufacturers can implement across a variety of electronic hardware configurations.

The enclosure detail diagram 300 includes an enclosure top view 110. The enclosure top view 110 visually illustrates an internal midframe, chassis, housing (e.g., housing 118), or casing that provides structural rigidity and defines internal physical compartments for the electronic device. The housing 118 can comprise an integral piece of material or a multi-part assembly. The housing 118 provides a physical medium through which various acoustic and optical channels are bored, molded, or otherwise defined to support internal hardware components.

Within a structural framework of the housing 118 shown in the enclosure top view 110, a front camera enclosure hole 112 forms a defined geometric void or receptacle. The front camera enclosure hole 112 provides an unobstructed physical pathway through the housing 118 to accommodate optical sensors or related hardware. The front camera enclosure hole 112 can exhibit a generally square or rectangular physical profile, or take other geometric forms depending on specific dimensions of optical modules it houses. In some implementations, the front camera enclosure hole 112 receives, supports, and aligns various sensor components. For example, the front camera enclosure hole 112 can house a front-facing visible light camera, an infrared camera, a time-of-flight (ToF) depth sensor, an ambient light sensor, a proximity sensor, or a facial recognition scanner.

Positioned in close proximity to the front camera enclosure hole 112, the housing 118 defines a speaker opening 116. The speaker opening 116 forms an acoustic ingress aperture extending through the structural material of the housing 118. The speaker opening 116 provides a physical conduit for acoustic energy, allowing sound waves generated by a rear-mounted internal audio driver to pass through the housing 118 and enter a fluidly coupled acoustic channel situated on a front-facing side of the electronic device. The speaker opening 116 exhibits a substantially triangular cross-sectional profile. The substantially triangular shape of the speaker opening 116 helps to shape an initial radiation pattern of acoustic waves as the acoustic waves enter the fluidly coupled acoustic channel. The speaker opening 116 sits laterally offset from the front camera enclosure hole 112 so that acoustic waves can propagate without causing physical interference or requiring overlapping footprints with optical hardware housed within the front camera enclosure hole 112. In some implementations, the substantially triangular cross-sectional profile of the speaker opening 116 comprises a substantially right-angled triangle. In some implementations, the substantially triangular cross-sectional profile of the speaker opening 116 comprises an isosceles right-angled triangle.

To facilitate acoustic routing, a vertical leg of the isosceles right-angled triangle may be positioned closer to a longitudinal centerline of the electronic device than a hypotenuse of the triangle, with the hypotenuse aligning substantially flush with the reference axis 212 and/or a first wall of the acoustic channel. Utilizing a triangular shape, rather than a larger rectangular cutout that matches a physical footprint of the underlying audio driver, can provide mechanical and acoustic benefits. Mechanically, reducing a void area of the speaker opening 116 helps preserve the structural integrity of the underlying enclosure, which can reduce the likelihood of the display assembly 106 cracking during assembly or use. Acoustically, a reduced opening size reduces the amount of surface area exposed to an overlying dust mesh (e.g., positioned between the top speaker 206 and the speaker opening 116). By reducing this exposure, the triangular shape inhibits the dust mesh from vibrating and creating an audible buzzing noise in response to acoustic pressure generated by the top speaker 206.

A reference axis 212 graphically illustrates a geometric alignment and a spatial orientation of the speaker opening 116 relative to the housing 118. The reference axis 212 forms an imaginary line or a phantom projection extending diagonally across the enclosure detail diagram 300. The reference axis 212 intersects the substantially triangular profile of the speaker opening 116 and aligns substantially flush with an internal structural wall of the speaker opening 116. The reference axis 212 extends at an oblique angle relative to longitudinal and latitudinal outer boundaries of the housing 118. In some implementations, the oblique angle formed by the reference axis 212 measures approximately forty-five degrees relative to a centerline of the electronic device. The reference axis 212 defines a linear trajectory along which an internal acoustic channel routes acoustic waves toward a peripheral edge of the electronic device.

In aspects, physical geometries depicted in the enclosure detail diagram 300 interact to manage a transmission of acoustic energy while accommodating internal optical sensors. An internal audio driver generates acoustic waves. The internal audio driver injects the acoustic waves into the speaker opening 116. The substantially triangular shape of the speaker opening 116 initially shapes a fluid flow of the acoustic waves. Following a trajectory defined by the reference axis 212, the acoustic waves propagate outward from the speaker opening 116 at an oblique angle. The acoustic waves travel along a straight boundary defined by the reference axis 212, guiding a fluid medium diagonally toward an exterior peripheral slot of the electronic device. This diagonal, off-axis routing maneuver allows the acoustic waves to smoothly bypass a physical footprint of the front camera enclosure hole 112. Consequently, the electronic device delivers directed audio to an external environment through an off-center channel while a separate optical module simultaneously captures light data through the centrally located front camera enclosure hole 112.

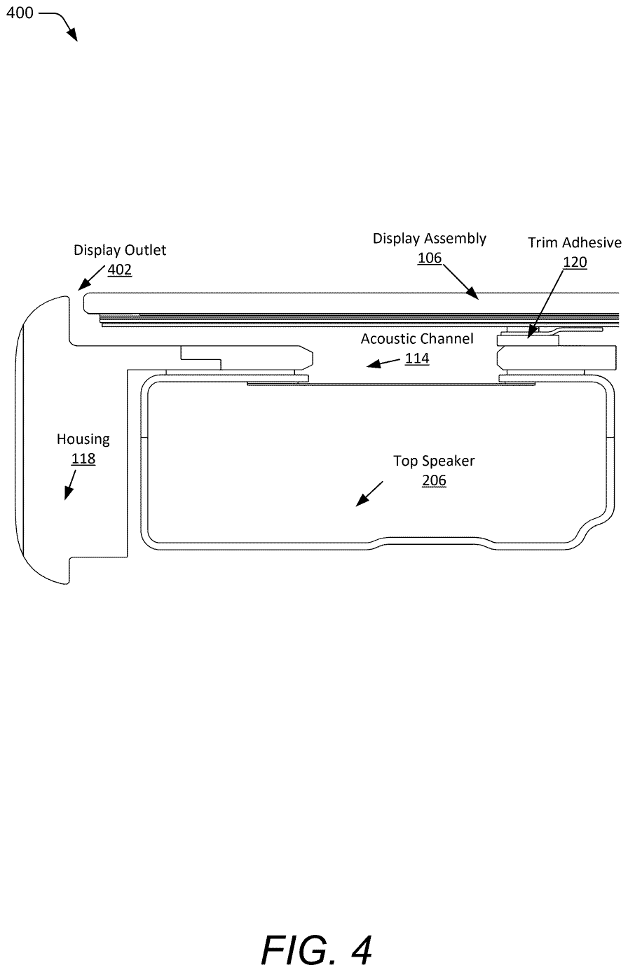

FIG. 4 illustrates a cross-sectional view of an acoustic structure for an acoustic transmission channel for an electronic device. A cross-sectional diagram 400 portrays a two-dimensional lateral slice through an upper peripheral edge of an electronic device, revealing a vertical stacking arrangement of internal and external hardware components. The cross-sectional diagram 400 illustrates how physical boundaries interact to form a fluid conduit connecting internal audio hardware to an external environment. In some implementations, a manufacturer can implement the architecture shown in the cross-sectional diagram 400 across a wide variety of electronic hardware configurations.

As illustrated in the cross-sectional diagram 400, a display assembly 106 serves as an upper physical boundary for the electronic device. The display assembly 106 provides visual output to a user and can present a physical surface for touch interactions. A bottom, inwardly facing surface of the display assembly 106 acts as a rigid acoustic ceiling that contains acoustic energy within internal spaces situated directly beneath the display assembly 106. The display assembly 106 can include various layered display technologies and stacked components.

An acoustic channel 114 forms a horizontal gap or physical void directly beneath the display assembly 106. The acoustic channel 114 defines a physically enclosed fluid pathway that routes acoustic energy outwardly toward a perimeter of the electronic device. The physical dimensions of the acoustic channel 114 establish a volumetric capacity for a fluid medium, such as ambient air, to carry acoustic waves horizontally or diagonally through an internal framework of the device. Maintaining a substantially constant cross-sectional depth along the length of the acoustic channel 114 can facilitate the manufacturing process and reduce machining complexity. The uniform depth of the acoustic channel 114 accommodates fabrication using a single-depth machining or molding pass, avoiding the need for multi-axis milling operations associated with varying depths, changing Z-heights, or stepped internal features.

A housing 118 defines a lower physical boundary and an outer peripheral sidewall for the acoustic channel 114. The housing 118 provides structural rigidity, internal mounting surfaces, and a physical enclosure for the electronic device. The housing 118 includes a raised shelf, step, or flange portion that physically forms a floor of the acoustic channel 114, reflecting acoustic waves upward. The housing 118 may be formed from a wide array of rigid or semi-rigid materials.

A trim adhesive 120 physically couples the display assembly 106 to the structural ledge of the housing 118. A thickness of the trim adhesive 120 establishes a fixed vertical offset between the display assembly 106 and the housing 118, thereby dictating a depth of the acoustic channel 114. In addition to physically securing the display assembly 106 to the housing 118, the trim adhesive 120 provides a fluid-tight acoustic seal or acoustic gasket. This seal secures lateral boundaries of the acoustic channel 114, inhibiting acoustic energy from leaking laterally out of the acoustic channel 114 and into unintended internal compartments of the electronic device. The trim adhesive 120 may include various bonding compounds.

A top speaker 206 mounts within an interior cavity defined by the housing 118, positioned beneath the acoustic channel 114. The top speaker 206 acts as an electromechanical transducer that converts electrical audio signals into physical acoustic waves. The top speaker 206 rests against an underlying shelf or mounting bracket of the housing 118. The top speaker 206 may incorporate a variety of acoustic driver technologies to generate sound. For example, the top speaker 206 can include a dynamic driver, an electrostatic driver, a piezoelectric transducer, a balanced armature driver, or a micro-electromechanical system (MEMS) speaker module. The housing 118 includes a physical aperture or port that fluidly connects an output face of the top speaker 206 to the acoustic channel 114 positioned above.

A display outlet 402 defines a physical exit aperture at an outer periphery of the electronic device where the display assembly 106 meets an outer lip of the housing 118. The display outlet 402 allows the acoustic channel 114 to fluidly communicate with an external environment. The display outlet 402 can take various physical forms depending on a desired aesthetic or structural design. For example, the display outlet 402 may comprise an elongated continuous slot, a physical gap, a series of micro-drilled perforations, or a mesh-covered aperture. In some implementations, the acoustic channel 114 intersects the elongated continuous slot at an oblique angle.

In an example, the structural elements shown in the cross-sectional diagram 400 collaborate to generate, route, and emit audio to a user. The top speaker 206 receives an electrical audio signal and physically actuates to produce acoustic waves. The top speaker 206 injects the acoustic waves upward through a port in the housing 118 and into the acoustic channel 114. Upon entering the acoustic channel 114, the acoustic waves strike the bottom surface of the display assembly 106, which acts as a rigid acoustic ceiling. The housing 118 provides a rigid floor that reflects the acoustic energy, while the trim adhesive 120 provides sealed side walls that trap the fluid medium, inhibiting it from escaping into the surrounding interior chassis. Confined vertically by the display assembly 106 and the housing 118, and confined laterally by the trim adhesive 120, the acoustic waves travel horizontally or diagonally through the fluid medium within the acoustic channel 114. The acoustic channel 114 guides the acoustic waves outward toward the edge of the electronic device. The acoustic waves arrive at the display outlet 402, and the display outlet 402 expels the acoustic waves outward, radiating the acoustic energy into the surrounding external environment.

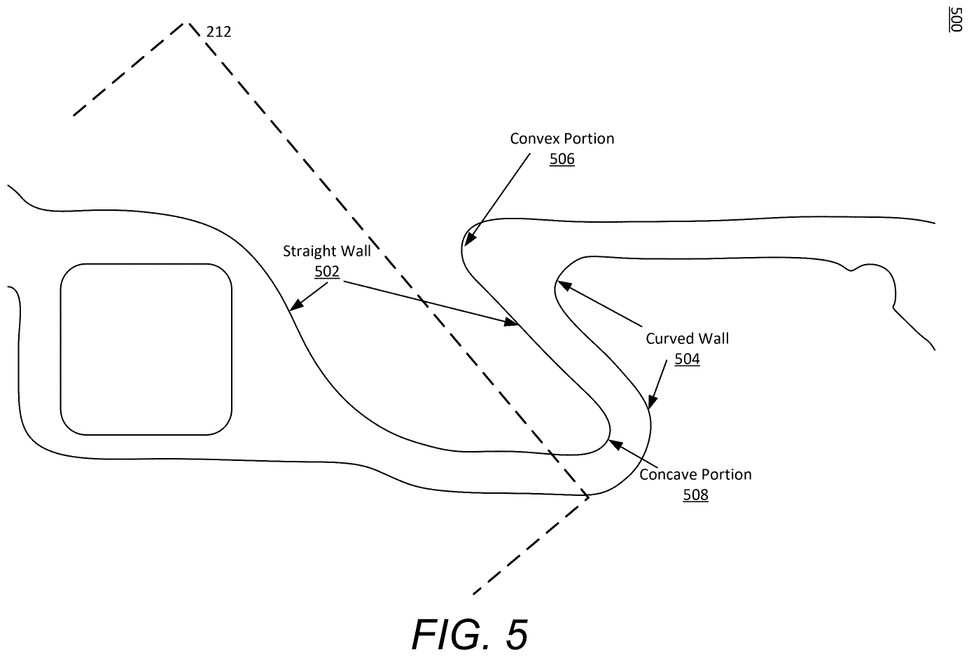

FIG. 5 illustrates a detailed geometric view of an acoustic channel for an acoustic transmission channel for an electronic device. A geometry detail diagram 500 provides a top-down, geometric perspective of lateral boundaries that define a fluid conduit within an electronic device. The geometry detail diagram 500 illustrates an asymmetric spatial layout of structural walls navigating through a physically constrained internal environment.

As illustrated in the geometry detail diagram 500, a reference axis 212 establishes a geometric trajectory or an imaginary diagonal projection extending through an internal space. The reference axis 212 provides a structural baseline indicating an oblique angle of physical alignment and fluid propagation. The reference axis 212 traverses the geometry detail diagram 500 to illustrate a direct, linear path outward toward a peripheral edge of the electronic device. The reference axis 212 visually aligns with an acoustic inlet to define a general direction for a travel of acoustic waves.

Following the general trajectory of the reference axis 212, a straight wall 502 forms a first lateral boundary for an acoustic channel. The straight wall 502 provides a direct, linear physical barrier that faces an interior volume of the fluid conduit. The straight wall 502 extends substantially parallel to, or coincident with, the reference axis 212. A manufacturer can form the straight wall 502 from various structural materials through numerous fabrication techniques. The straight wall 502 establishes a consistent, linear physical boundary that guides a fluid medium along a predictable diagonal vector without causing abrupt physical turbulence.

Spaced apart from the straight wall 502, a curved wall 504 forms a second lateral boundary for the acoustic channel. The curved wall 504 features an undulating, sweeping, or non-linear physical profile that structurally contrasts with the linear nature of the straight wall 502. The curved wall 504 structurally navigates around an adjacent internal physical obstruction, such as a hardware mounting bracket or a sensor receptacle, avoiding spatial overlap with surrounding components. The curved wall 504 may be disposed between the camera and the straight wall 502. The asymmetric pairing of the straight wall 502 on a first side and the curved wall 504 on a second side defines a fluid pathway that routes acoustic waves diagonally while managing physical space constraints.

To facilitate fluid dynamic routing, the curved wall 504 features a specific geometric profile including a concave portion 508 and a convex portion 506. Following a flow path of the acoustic channel, the curved wall 504 transitions from the concave portion 508 into the convex portion 506. The concave portion 508 recesses outwardly away from the interior of the acoustic channel, curving concavely relative to the interior to expand a physical distance from the straight wall 502. The concave portion 508 smoothly expands the fluid flow as it receives acoustic waves from the inlet. The convex portion 506 then protrudes inwardly toward the interior volume of the acoustic channel, curving convexly relative to the interior of the acoustic channel to reach toward the straight wall 502. The convex portion 506 gently shapes the fluid flow to route the acoustic waves around a structural obstacle, such as a physical footprint of the adjacent camera. The concave portion 508 and the convex portion 506 connect to form a smooth transition. A manufacturer may design the convex portion 506 and the concave portion 508 using a variety of mathematical profiles, such as, for example, a Bezier curve, a cubic spline, a parabolic arc, or an elliptical sweep.

During operation, the geometric boundaries depicted in the geometry detail diagram 500 interact to manage a transmission of acoustic energy. A fluid medium carrying acoustic waves enters the physical space between the straight wall 502 and the curved wall 504. The straight wall 502 receives the acoustic waves and reflects them along a direct, linear path governed by the reference axis 212, guiding the acoustic energy diagonally outward. Concurrently, the curved wall 504 manages a portion of the fluid medium carrying the acoustic waves. The convex portion 506 steers a fluid flow to navigate an interior physical corner, while the concave portion 508 smoothly expands the fluid flow to route the acoustic waves around a structural obstacle. The straight wall 502, the curved wall 504, the convex portion 506, and the concave portion 508 operate in concert to guide the fluid medium through an asymmetric fluid conduit, routing an acoustic output toward an external environment.

### Conclusion

Although aspects of an acoustic transmission channel for an electronic device have been described in language specific to features and/or methods, the subject of the appended claims is, as recited by any of the previous examples, not necessarily limited to the specific features or methods described. Rather, the specific features and methods are disclosed as example implementations of an acoustic transmission channel for an electronic device, and other equivalent features and methods are intended to be within the scope of the appended claims. Further, various aspects of an acoustic transmission channel for an electronic device are described, and it is to be appreciated that each described aspect may be implemented independently or in connection with one or more other described aspects.

What is claimed is:

1. An electronic device, comprising:
a housing;
a display assembly coupled to the housing;
an acoustic outlet defined at a periphery of the electronic device;
a camera disposed within the housing;
an audio driver disposed within the housing and laterally offset from the camera; and
an acoustic channel defined within the housing and fluidly coupling the audio driver to the acoustic outlet, the acoustic channel comprising:
an inlet opening adjacent to the audio driver, the inlet opening having a substantially triangular shape;
a first wall extending from the inlet opening toward the acoustic outlet; and
a second wall spaced apart from the first wall, the second wall disposed between the camera and the first wall, the first wall being substantially straight and the second wall comprising a curved profile.

2. The electronic device of claim 1, wherein the substantially triangular shape of the inlet opening is a substantially right-angled triangle comprising a hypotenuse.

3. The electronic device of claim 2, wherein the hypotenuse is aligned to be substantially flush with the first wall of the acoustic channel.

4. The electronic device of claim 1, wherein the curved profile of the second wall comprises a first portion that is convex relative to an interior of the acoustic channel, and a second portion that is concave relative to the interior of the acoustic channel, the first portion and the second portion configured to guide acoustic output around the camera.

5. The electronic device of claim 1, wherein the acoustic channel extends along an axis oriented at an oblique angle relative to a longitudinal centerline of the electronic device.

6. The electronic device of claim 5, wherein the oblique angle is approximately 45 degrees.

7. The electronic device of claim 1, wherein the acoustic channel comprises a substantially constant cross-sectional depth from the inlet opening to the acoustic outlet.

8. The electronic device of claim 1, further comprising an adhesive layer disposed between the housing and the display assembly, wherein a depth of the acoustic channel is defined at least in part by a thickness of the adhesive layer.

9. The electronic device of claim 1, wherein the acoustic outlet comprises an elongated slot, and wherein the acoustic channel intersects the elongated slot at an oblique angle.

10. An acoustic structure for an electronic device, comprising:
an enclosure;
an audio driver disposed within the enclosure;
an acoustic outlet formed at an exterior of the enclosure; and
an acoustic channel fluidly coupling the audio driver to the acoustic outlet, the acoustic channel comprising:
an inlet opening fluidly coupled to the audio driver, the inlet opening shaped as a substantially right-angled triangle;
a substantially straight first wall extending from the inlet opening to the acoustic outlet; and
a curved second wall extending from the inlet opening to the acoustic outlet and spaced apart from the first wall, the acoustic channel comprising a substantially constant cross-sectional depth from the inlet opening to the acoustic outlet.
